(19) United States
(12) Patent Application Publication
(10) Pub. No.: US 2014/0024264 A1
(43) Pub. Date: Jan. 23, 2014

(54) PORTABLE ELECTRONIC DEVICE

(71) Applicants: HSUAN-HO CHUNG, Chang An Town (CN); Yu-Hung Lin, Chang An Town (CN)

(72) Inventors: HSUAN-HO CHUNG, Chang An Town (CN); Yu-Hung Lin, Chang An Town (CN)

(21) Appl. No.: 13/551,630

(22) Filed: Jul. 18, 2012

(51) Int. Cl. H01R 24/28

(52) U.S. Cl. 439/676

(57) ABSTRACT

The portable electronic device contains an electronic module and an insulating member slidably configured on the electronic module. The electronic module has a contact set on a major side which contains a first contact set, a second contact set, a third contact set, and a fourth contact set. The insulating member has at least a terminal set which contains a first terminal set, a second terminal set, a third terminal set, and a fourth terminal set, corresponding to the contacts of the first, second, third, and fourth contact sets, respectively. When the insulating member is slid on the electronic module, the terminals of the terminal set thereby establish contact with the corresponding contacts of the contact set. The friction between the terminals and the contacts rubs their oxidization off. The sliding configuration between the insulating member and the electronic module requires no soldering and as such prevents the reliability issue.

### TECHNICAL FIELD OF THE INVENTION

The present invention is generally related to portable electronic devices, and more particularly to a portable reader device for accessing a memory card through a USB interface.

### DESCRIPTION OF THE PRIOR ART

To connect various electronic devices such as computers, digital cameras, portable drives, etc., and to access the stored data of these devices, USB is a most popular interface these days. On the other hand, memory card is also a very popular means for expanding storage capacity for electronic devices.

However, the memory card cannot directly connect with a USB interface but requires a card reader device which has a USB port and a card port. When a memory card is plugged into the card port, its stored data can be accessed by connecting the card reader device's USB port to another electronic device. However, if the card reader device is not used for a period of time, the USB port's differential terminals could easily be oxidized. Moreover, during the manufacturing process, soldering is common means but it is costly, time consuming, and susceptible to reliability issue. When the card reader device is placed in a user's pocket, the USB port often gets hooked with the fabrics in the pocket and thereby gets damaged.

### SUMMARY OF THE INVENTION

A major objective of the present invention is to provide a portable electronic device for accessing memory card that does not required soldering but only simple assembly.

A second objective of the present invention is to provide a portable electronic device for accessing memory card so that problem of missing solder of solder skip is avoided.

A third objective of the present invention is to provide a portable electronic device for accessing memory card where oxidation of its terminals and contacts is automatically rubbed off for superior reliability and extended operational life.

A fourth objective of the present invention is to provide a portable electronic device for accessing memory card that wouldn't get hooked with the fabrics when being carried in the pocket.

To achieve the objectives, the portable electronic device contains an electronic module and an insulating member slidably configured on the electronic module. The electronic module has a contact set on a major side of the electronic module. The contact set contains a first contact set, a second contact set, a third contact set, and a fourth contact set. The insulating member has at least a terminal set which contains a first terminal set, a second terminal set, a third terminal set, and a fourth terminal set, corresponding to the contacts of the first, second, third, and fourth contact sets, respectively. When the insulating member is slidably configured on the electronic module, the terminals of the terminal set thereby establish contact with the corresponding contacts of the contact set. The friction between the terminals and the contacts rubs their oxidization off. The sliding configuration between the insulating member and the electronic module requires no soldering and as such prevents the problem of missing solder. The carriage of the portable electronic device wouldn't get hooked with the packet fabrics.

With the present invention, the oxidization problem of the prior arts is prevented. Moreover, during the manufacturing process, no soldering which is costly, time-consuming, and susceptible to reliability issue is required. When the portable electronic device is placed in a user's pocket, it would not get hooked with the fabrics in the pocket.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing a portable electronic device according to a first embodiment of the present invention.

FIG. 2 is a perspective break-down diagram showing the various components of the portable electronic device of FIG. 1.

FIG. 3 is another perspective break-down diagram showing the various components of the portable electronic device of FIG. 1.

FIG. 4 is a sectional diagram showing the portable electronic device of FIG. 1 before a memory card is plugged.

FIG. 5 is a sectional diagram showing the portable electronic device of FIG. 1 after a memory card is plugged.

FIG. 6 is a sectional diagram showing the portable electronic device of FIG. 1 after a memory card is plugged and it is connected to a USB port.

FIG. 7 is a perspective break-down diagram showing the various components of a portable electronic device according to a second embodiment of the present invention.

FIG. 8 is another perspective break-down diagram showing the various components of the portable electronic device of FIG. 7.

FIG. 9 is a perspective break-down diagram showing the various components of a portable electronic device according to a third embodiment of the present invention.

FIG. 10 is another perspective break-down diagram showing the various components of the portable electronic device of FIG. 9.

FIG. 11 is perspective diagram showing a portable electronic device according to a fourth embodiment of the present invention.

FIG. 12 is a perspective break-down diagram showing the various components of the portable electronic device of FIG. 11.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

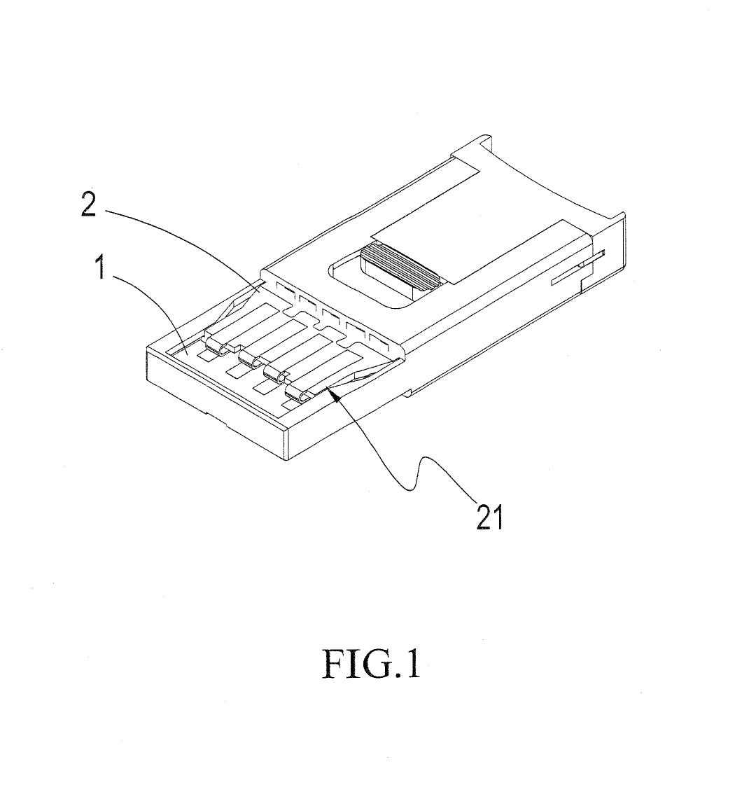

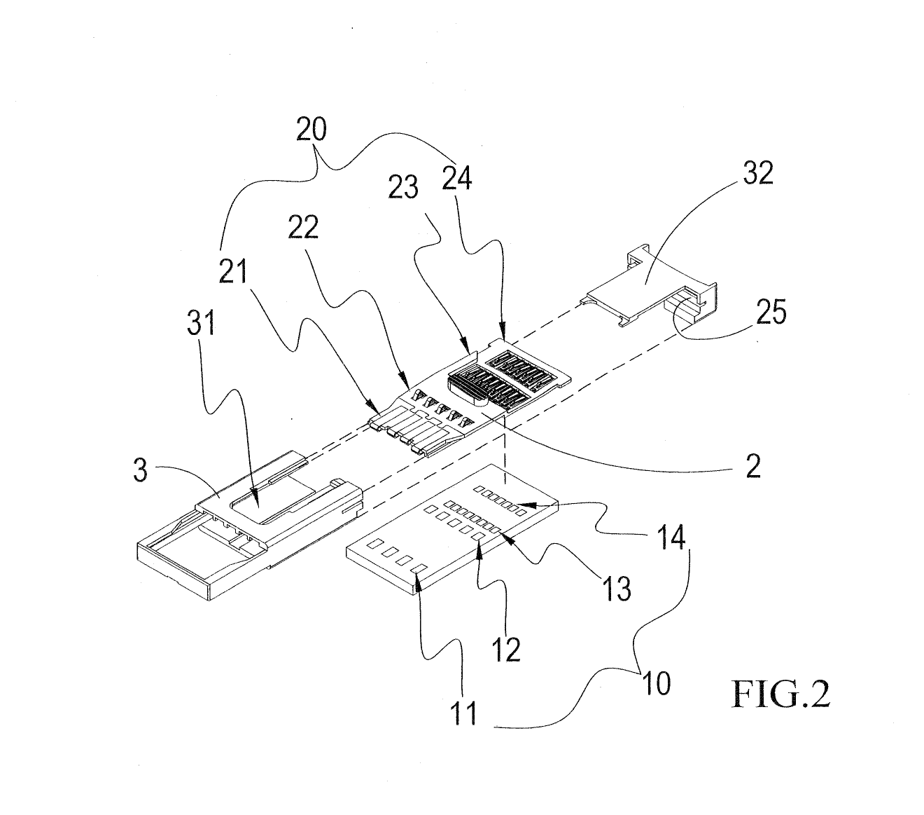

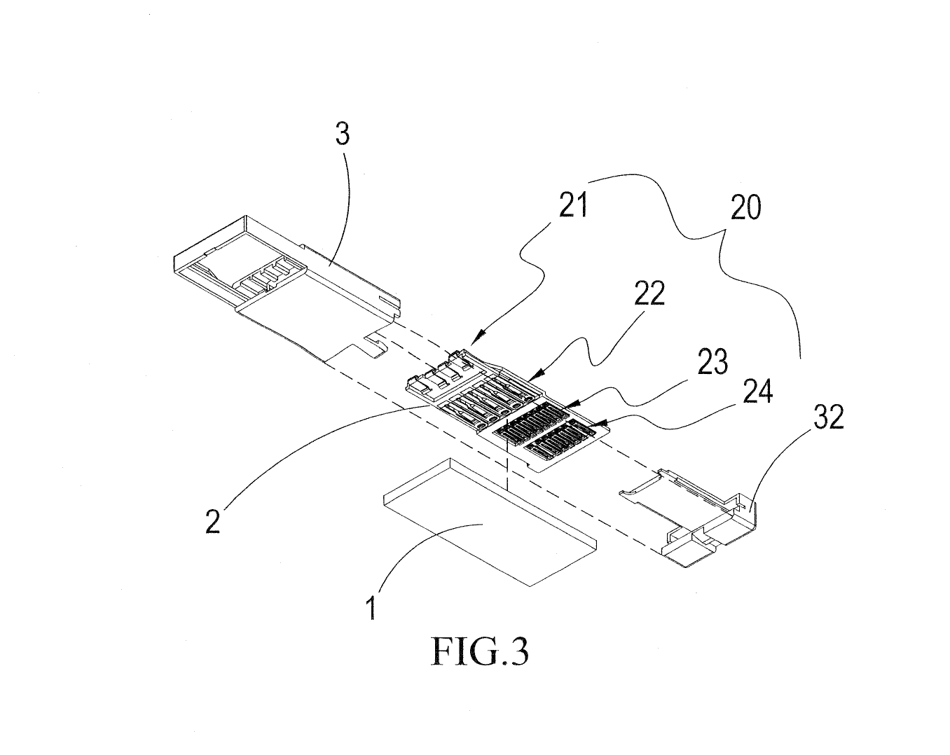

As shown in FIGS. 1 to 3, a portable electronic device according to a first embodiment of the present invention contains an electronic module 1, an insulating member 2 slidably configured on the electronic module 1, and a casing 3.

The electronic module 1 has a contact set 10 on a major side of the electronic module 1. The contact set 10 contains a first contact set 11, a second contact set 12, a third contact set 13, and a fourth contact set 14, arranged sequentially in the above order from one end of the electronic module 1 to the other end.

The insulating member 2 has at least a terminal set 20 which contains a first terminal set 21 corresponding to the contacts of the first contact set 11, a second terminal set 22 having flexible terminals corresponding to the contacts of the second contact set 12, a third terminal set 23 having flexible terminals corresponding to the contacts of the third contact set 13, and a fourth terminal set 24 having flexible terminals corresponding to the contacts of the fourth contact set 24, arranged in the above order from one end of the insulating member 2 to the other end. Above a major side of the insulating member 2, a card space 25 is reserved for the plugging of a memory card. The terminals of the first terminal set 21 are flatly arranged along the major side of the insulating member 2 and bended towards the other major side to form flexible tips. When the insulating member 2 is slidably configured on the electronic module 1, the terminals of the terminal set 20 thereby establish contact with the corresponding contacts of the contact set 10.

The casing 3 has an accommodation space 31 for receiving the electronic module 1 and the insulating member 2. A cover 32 is plugged into the accommodation space 31 to confine the electronic module 1 and the insulating member 2 inside the accommodation space 31.

Additionally, the portable electronic device can be configured in a protective housing (not shown). To expose and use the portable electronic device from the protective housing, the portable electronic device can be swung out, slid out, pulled out, or revealed by flipping open a cover or by removing a cap of the protective housing.

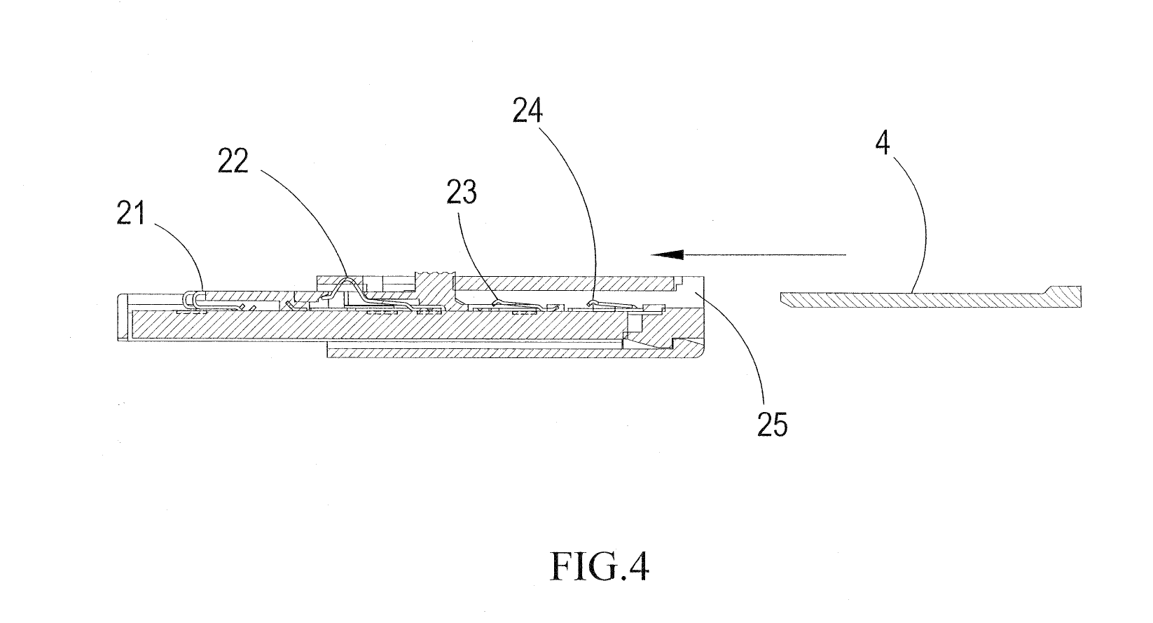

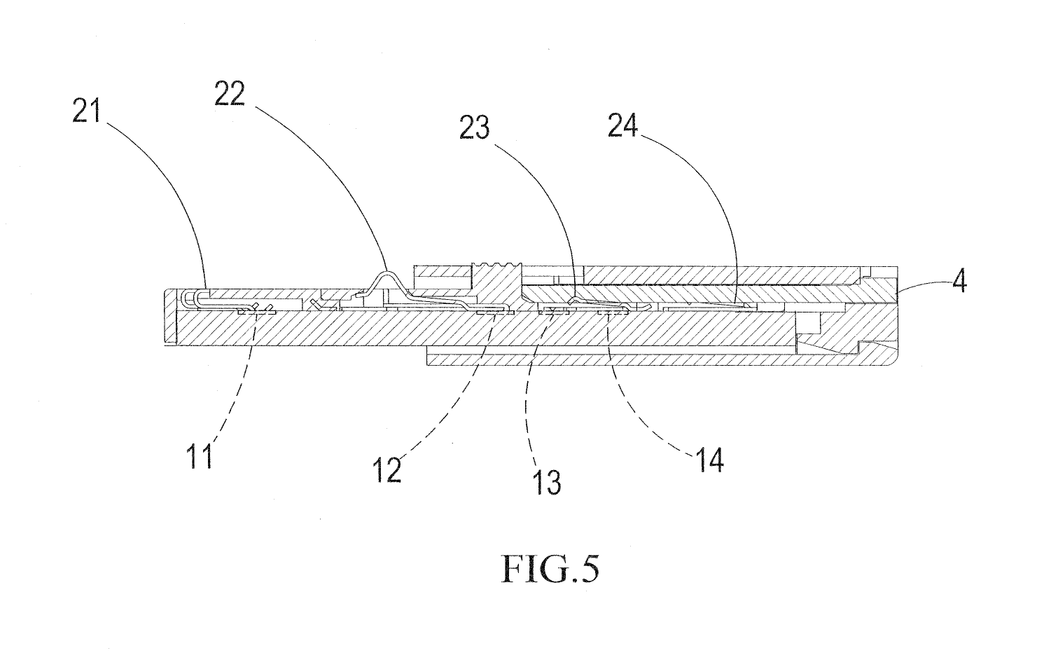

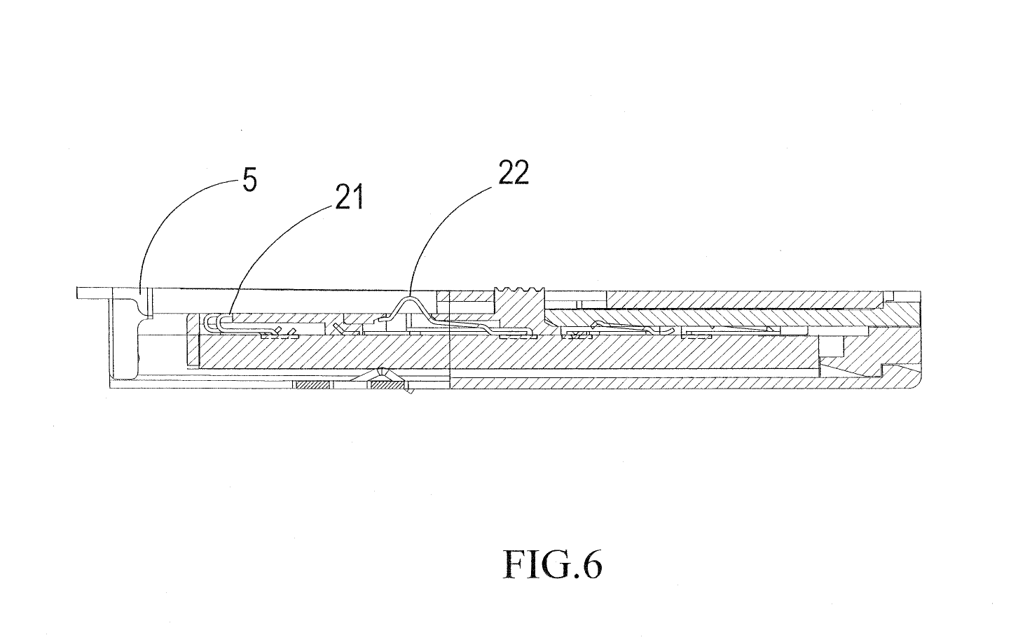

As shown in FIGS. 4 to 6, the portable electronic device is used as follows. Firstly, a memory card 4 is plugged into the card space 25, and the various differential contacts on the memory card 4 are in contact with the terminals of the first, second, third, and fourth terminal sets 21, 22, 23, and 24, respectively. In the meantime, the force pushing the memory card 4 also drives the insulating member 2 to slide towards an end of the electronic module 1. Then, the terminals of the first, second, third, and fourth terminal sets 21, 22, 23, and 24 thereby establish contact and electrical conduction with the contacts of the first, second, third, and fourth contact sets 11, 12, 13, and 14, respectively. Subsequently, the portable electronic device can be plugged into a USB female socket 5. Please note that the electronic module 1 can be an electronic module for a card reader, a flash memory, an adaptor, a wireless transmitter, or other miniature electronic module.

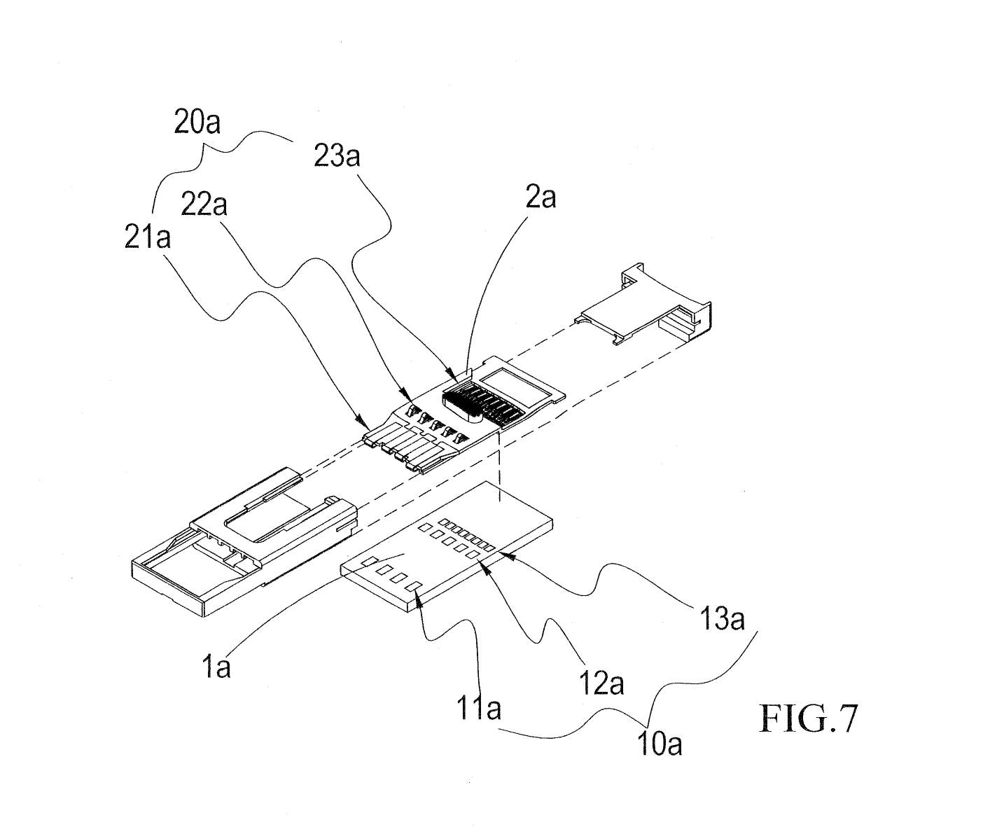

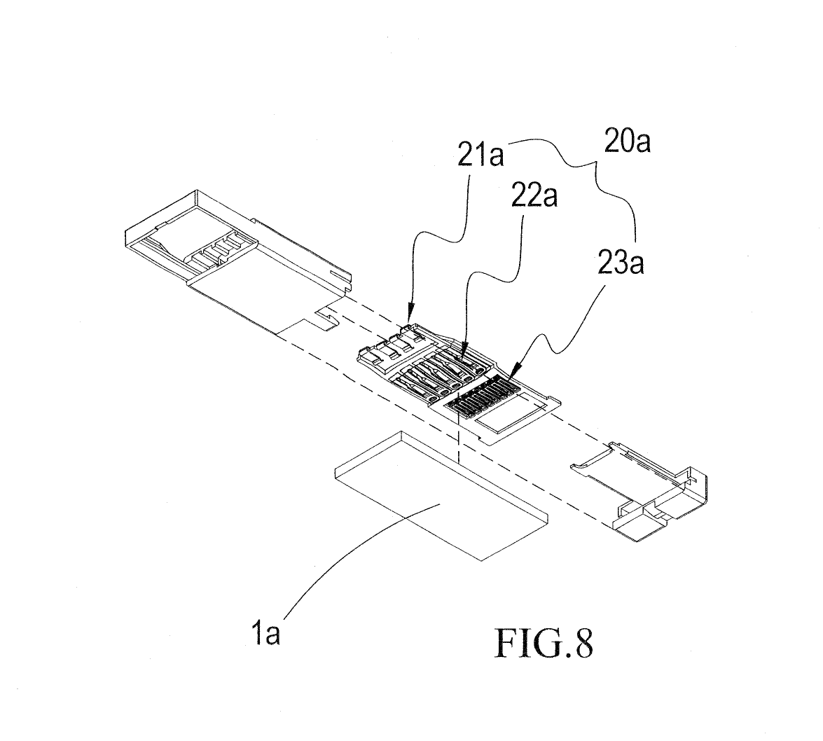

As shown in FIGS. 7 and 8, a portable electronic device according to a second embodiment of the present invention contains an electronic module 1a, and an insulating member 2a slidably configured on the electronic module 1a.

The electronic module 1a has a contact set 10a on a major side of the electronic module la. The contact set 10a contains a first contact set 11a, a second contact set 12a, and a third contact set 13a, arranged sequentially in the above order from one end of the electronic module 1a to the other end.

The insulating member 2a has at least a terminal set 20a which contains a first terminal set 21a corresponding to the contacts of the first contact set 11a, a second terminal set 22a having flexible terminals corresponding to the contacts of the second contact set 12a, and a third terminal set 23a having flexible terminals corresponding to the contacts of the third contact set 13a, arranged in the above order from one end of the insulating member 2a to the other end. The terminals of the first terminal set 21a are flatly arranged along a major side of the insulating member 2a and bended towards the other major side to form flexible tips.

Additionally, the portable electronic device can be configured in a protective housing (not shown). To expose and use the portable electronic device from the protective housing, the portable electronic device can be swung out, slid out, pulled out, or revealed by flipping open a cover or by removing a cap.

When a force pushing a memory card also drives the insulating member 2a to slide towards an end of the electronic module 1a, the terminals of the first, second, and third terminal sets 21a, 22a, and 23a thereby establish contact and electrical conduction with the contacts of the first, second, and third contact sets 11a, 12a, and 13a, respectively.

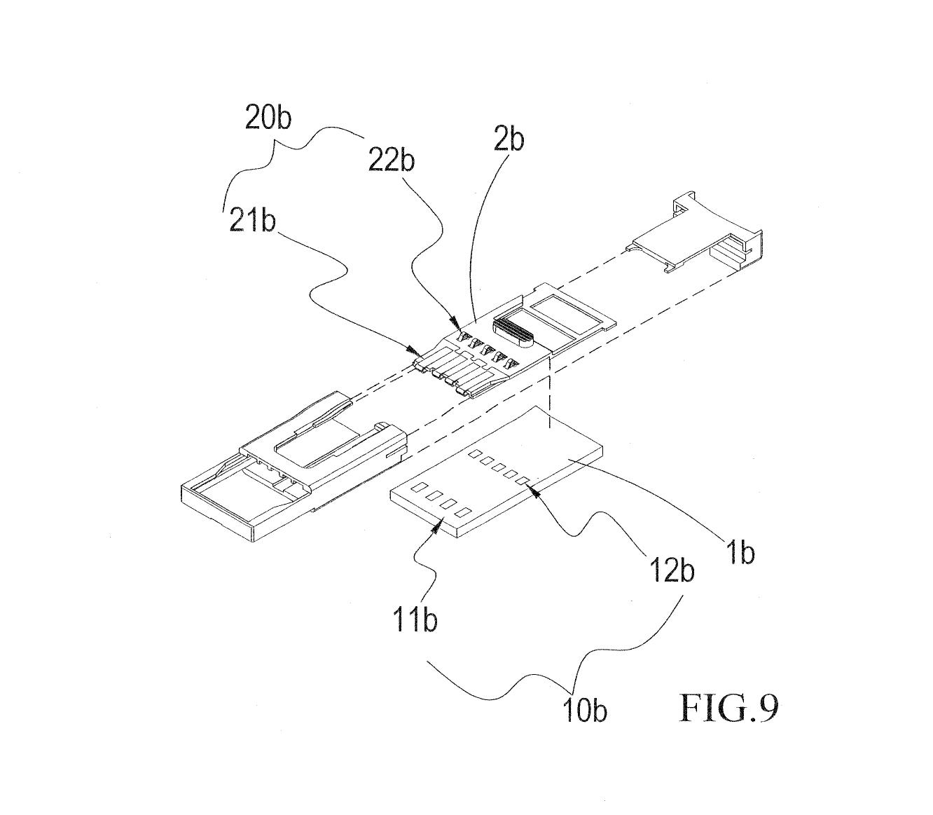

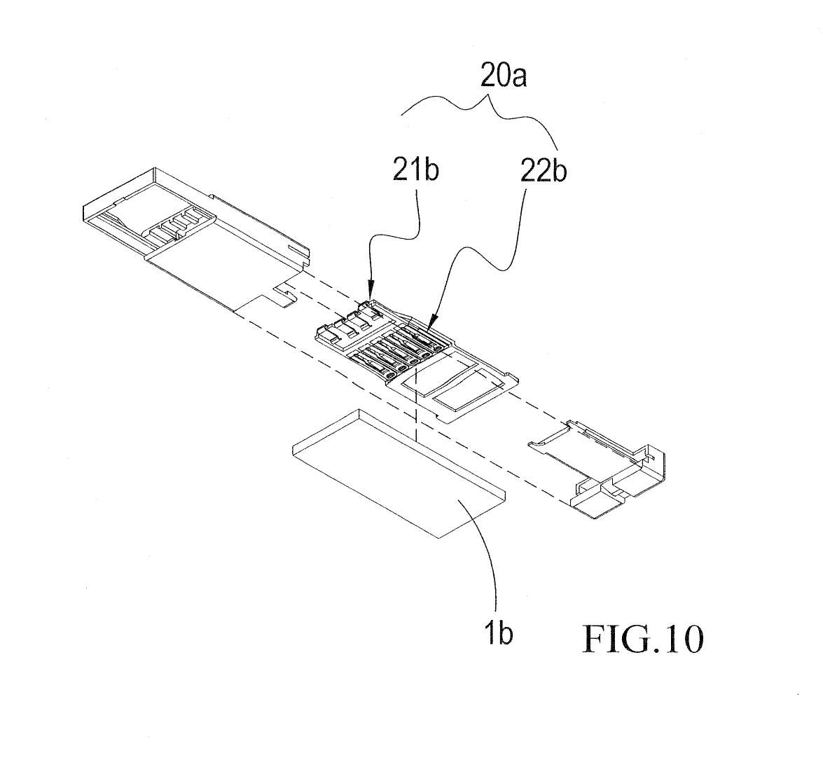

As shown in FIGS. 9 and 10, a portable electronic device according to a third embodiment of the present invention contains an electronic module 1b, and an insulating member 2b slidably configured on the electronic module 1a.

The electronic module 1b has a contact set 10b on a major side of the electronic module 1b. The contact set 10b contains a first contact set 11b, and a second contact set 12b at a side to the first contact 11b.

The insulating member 2b has at least a terminal set 20b which contains a first terminal set 21b corresponding to the contacts of the first contact set 11b, and a second terminal set 22b having flexible terminals corresponding to the contacts of the second contact set 12b arranged at a side of the first terminal set 21b. The terminals of the first terminal set 21b are flatly arranged along a major side of the insulating member 2b and bended towards the other major side to form flexible tips.

Additionally, the portable electronic device can be configured in a protective housing (not shown). To expose and use the portable electronic device from the protective housing, the portable electronic device can be swung out, slid out, pulled out, or revealed by flipping open a cover or by removing a cap.

When a force pushing a memory card also drives the insulating member 2b to slide towards an end of the electronic module 1b, the terminals of the first and second terminal sets 21b and 22b thereby establish contact and electrical conduction with the contacts of the first and second contact sets 11b and 12b, respectively.

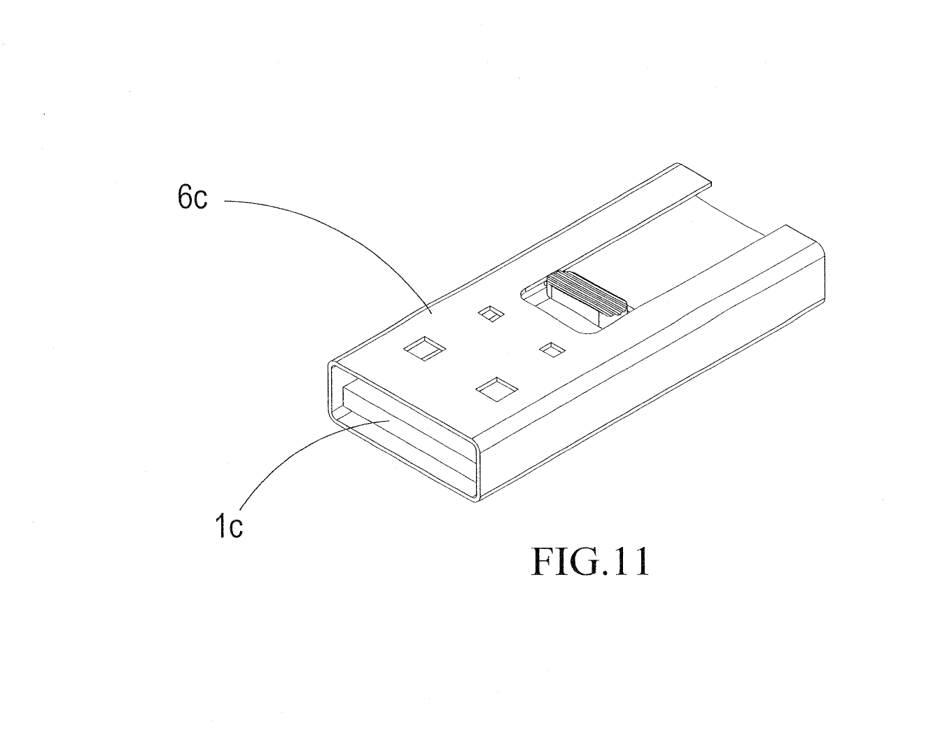

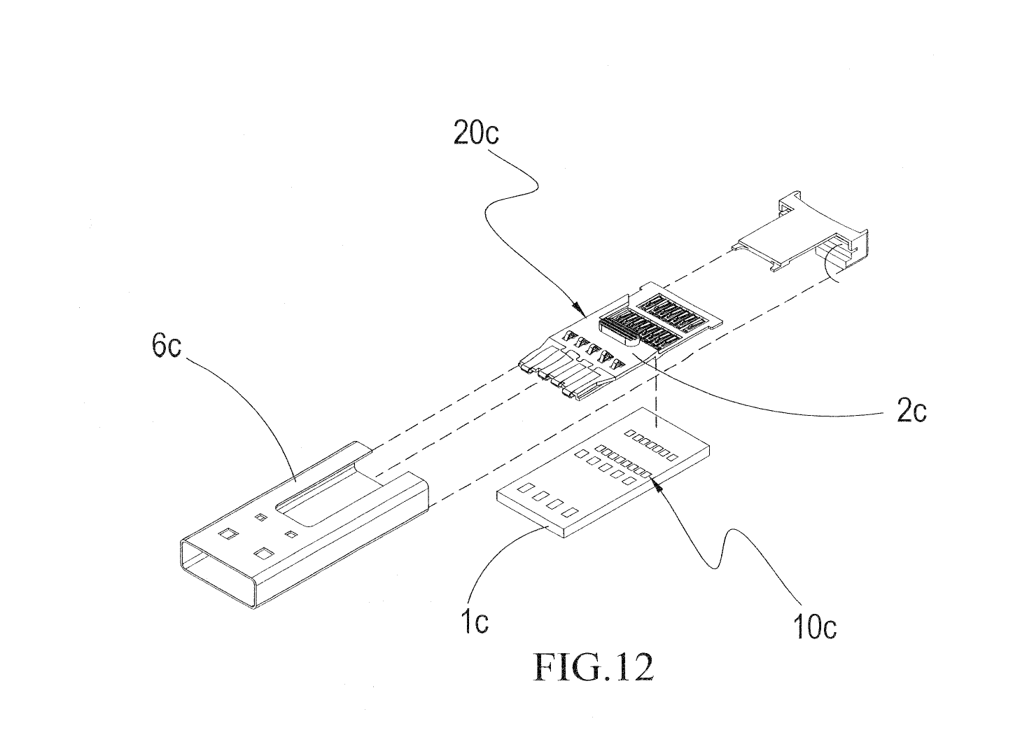

As shown in FIGS. 11 and 12, a portable electronic device according to a fourth embodiment of the present invention contains an electronic module 1c, an insulating member 2c slidably configured on the electronic module 1c, and a shielding housing 6c housing the electronic module 1c and the insulating member 2c.

The electronic module 1c has a contact set 10c on a major side of the electronic module 1c. The insulating member 2c has at least a terminal set 20c.

When a force pushing a memory card also drives the insulating member 2c to slide towards an end of the electronic module 1c, the terminals of the terminal set 20c thereby establish contact and establish electrical conduction with the contacts of the contact set 10c, respectively.

As described above, a portable electronic device of the present invention can be housed either in a protective housing or in a shielding housing, for protection and positioning.

The gist of the present invention lies in the following.

Firstly, the force pushing the memory card also drives the insulating member 2 so that the terminals of the first, second, third, and fourth terminal sets 21, 22, 23, and 24 thereby establish contact and electrical conduction with the contacts of the first, second, third, and fourth contact sets 11, 12, 13, and 14, respectively. In other words, the portable electronic device does not require soldering but only simply assembly to function.

Secondly, since soldering is not required, the problem of missing solder or solder skip is avoided.

Thirdly, also due to the electrical conduction established between the terminals of the insulating member 2 and the contacts of the electronic module 1, the oxidation on the terminals would be rubbed off by the friction between the terminals and the contacts. The portable electronic device therefore has a superior reliability and longer operational life.

Fourthly, also due to the sliding configuration between the insulating member 2 and the electronic module 1, the portable electronic device wouldn't get hooked with the fabrics when being carried in the pocket.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A portable electronic device, comprising:
an electronic module having a contact set on a major side; and
an insulating member slidably configured on the electronic module having at least a terminal set corresponding to the contact set;
wherein, when the insulating member is slid on the electronic module, the terminals of the terminal set thereby establish contact with the corresponding contacts of the contact set.

2. A portable electronic device, comprising:
an electronic module having a contact set on a major side;
an insulating member slidably configured on the electronic module having at least a terminal set corresponding to the contact set; and
a casing having an accommodation space for receiving the electronic module and the insulating member; and a cover plugged into the accommodation space to confine the electronic module and the insulating member inside the accommodation space;
wherein, when the insulating member is slid on the electronic module, the terminals of the terminal set thereby establish contact with the corresponding contacts of the contact set.

3. The portable electronic device according to claim 2, wherein the contact set contains a first contact set, a second contact set, a third contact set, and a fourth contact set, arranged sequentially in the above order from one end of the electronic module to the other end; the terminal set contains a first terminal set corresponding to the contacts of the first contact set, a second terminal set having flexible terminals corresponding to the contacts of the second contact set, a third terminal set having flexible terminals corresponding to the contacts of the third contact set, and a fourth terminal set having flexible terminals corresponding to the contacts of the fourth contact set, arranged in the above order from one end of the insulating member to the other end; and, above a major side of the insulating member, a card space is reserved for the plugging of a memory card.

4. The portable electronic device according to claim 2, wherein the contact set contains a first contact set, a second contact set, a third contact set, and a fourth contact set, arranged sequentially in the above order from one end of the electronic module to the other end; the terminal set contains a first terminal set corresponding to the contacts of the first contact set, a second terminal set having flexible terminals corresponding to the contacts of the second contact set, a third terminal set having flexible terminals corresponding to the contacts of the third contact set, and a fourth terminal set having flexible terminals corresponding to the contacts of the fourth contact set, arranged in the above order from one end of the insulating member to the other end; and the terminals of the first terminal set are flatly arranged along the major side of the insulating member and bended towards the other major side to form flexible tips.

5. The portable electronic device according to claim 2, wherein the contact set contains a first contact set, a second contact set, and a third contact set, arranged sequentially in the above order from one end of the electronic module to the other end; and the terminal set contains a first terminal set corresponding to the contacts of the first contact set, a second terminal set having flexible terminals corresponding to the contacts of the second contact set, and a third terminal set having flexible terminals corresponding to the contacts of the third contact set, arranged in the above order from one end of the insulating member to the other end.

6. The portable electronic device according to claim 2, wherein the contact set contains a first contact set, a second contact set, and a third contact set, arranged sequentially in the above order from one end of the electronic module to the other end; the terminal set contains a first terminal set corresponding to the contacts of the first contact set, a second terminal set having flexible terminals corresponding to the contacts of the second contact set, and a third terminal set having flexible terminals corresponding to the contacts of the third contact set, arranged in the above order from one end of the insulating member to the other end; and the terminals of the first terminal set are flatly arranged along the major side of the insulating member and bended towards the other major side to form flexible tips.

7. The portable electronic device according to claim 2, wherein the contact set contains a first contact set and a second contact set, arranged sequentially in the above order from one end of the electronic module to the other end; and the terminal set contains a first terminal set corresponding to the contacts of the first contact set, and a second terminal set having flexible terminals corresponding to the contacts of the second contact set.

8. The portable electronic device according to claim 2, wherein the contact set contains a first contact set and a second contact set, arranged sequentially in the above order from one end of the electronic module to the other end; the terminal set contains a first terminal set corresponding to the contacts of the first contact set, and a second terminal set having flexible terminals corresponding to the contacts of the second contact set; and the terminals of the first terminal set are flatly arranged along the major side of the insulating member and bended towards the other major side to form flexible tips.

9. The portable electronic device according to claim 2, further comprising a protective housing; wherein, to expose and use the portable electronic device from the protective housing, the portable electronic device is swung out, slid out, pulled out, or revealed by flipping open a cover or by removing a cap of the protecting housing.

10. A portable electronic device, comprising:
an electronic module having a contact set on a major side;
an insulating member slidably configured on the electronic module having at least a terminal set corresponding to the contact set; and
a shielding housing for receiving the electronic module and the insulating member;
wherein, when the insulating member is slid on the electronic module, the terminals of the terminal set thereby establish contact with the corresponding contacts of the contact set.

11. The portable electronic device according to claim 10, wherein the contact set contains a first contact set, a second contact set, a third contact set, and a fourth contact set, arranged sequentially in the above order from one end of the electronic module to the other end; the terminal set contains a first terminal set corresponding to the contacts of the first contact set, a second terminal set having flexible terminals corresponding to the contacts of the second contact set, a third terminal set having flexible terminals corresponding to the contacts of the third contact set, and a fourth terminal set having flexible terminals corresponding to the contacts of the fourth contact set, arranged in the above order from one end of the insulating member to the other end; and, above a major side of the insulating member, a card space is reserved for the plugging of a memory card.

12. The portable electronic device according to claim 10, wherein the contact set contains a first contact set, a second contact set, a third contact set, and a fourth contact set, arranged sequentially in the above order from one end of the electronic module to the other end; the terminal set contains a first terminal set corresponding to the contacts of the first contact set, a second terminal set having flexible terminals corresponding to the contacts of the second contact set, a third terminal set having flexible terminals corresponding to the contacts of the third contact set, and a fourth terminal set having flexible terminals corresponding to the contacts of the fourth contact set, arranged in the above order from one end of the insulating member to the other end; and the terminals of the first terminal set are flatly arranged along the major side of the insulating member and bended towards the other major side to form flexible tips.

13. The portable electronic device according to claim 10, wherein the contact set contains a first contact set, a second contact set, and a third contact set, arranged sequentially in the above order from one end of the electronic module to the other end; and the terminal set contains a first terminal set corresponding to the contacts of the first contact set, a second terminal set having flexible terminals corresponding to the contacts of the second contact set, and a third terminal set having flexible terminals corresponding to the contacts of the third contact set, arranged in the above order from one end of the insulating member to the other end.

14. The portable electronic device according to claim 10, wherein the contact set contains a first contact set, a second contact set, and a third contact set, arranged sequentially in the above order from one end of the electronic module to the other end; the terminal set contains a first terminal set corresponding to the contacts of the first contact set, a second terminal set having flexible terminals corresponding to the contacts of the second contact set, and a third terminal set having flexible terminals corresponding to the contacts of the third contact set, arranged in the above order from one end of the insulating member to the other end; and the terminals of the first terminal set are flatly arranged along the major side of the insulating member and bended towards the other major side to form flexible tips.

15. The portable electronic device according to claim 10, wherein the contact set contains a first contact set and a second contact set, arranged sequentially in the above order from one end of the electronic module to the other end; and the terminal set contains a first terminal set corresponding to the contacts of the first contact set, and a second terminal set having flexible terminals corresponding to the contacts of the second contact set.

16. The portable electronic device according to claim 10, wherein the contact set contains a first contact set and a second contact set, arranged sequentially in the above order from one end of the electronic module to the other end; the terminal set contains a first terminal set corresponding to the contacts of the first contact set, and a second terminal set having flexible terminals corresponding to the contacts of the second contact set; and the terminals of the first terminal set are flatly arranged along the major side of the insulating member and bended towards the other major side to form flexible tips.

17. The portable electronic device according to claim 10, further comprising a protective housing; wherein, to expose and use the portable electronic device from the protective housing, the portable electronic device is swung out, slid out, pulled out, or revealed by flipping open a cover or by removing a cap of the protecting housing.
